(19) United States
(12) Patent Application Publication
(10) Pub. No.: US 2016/0085518 A1
(43) Pub. Date: Mar. 24, 2016

(54) SYSTEMS AND METHODS FOR IMAGING AND GENERATION OF EXECUTABLE PROCESSOR INSTRUCTIONS BASED ON ORDERED OBJECTS

(71) Applicant: Jang Hee I, New York, NY (US)

(72) Inventor: Jang Hee I, New York, NY (US)

(21) Appl. No.: 14/859,669

(22) Filed: Sep. 21, 2015

Related U.S. Application Data
(60) Provisional application No. 62/053,206, filed on Sep. 21, 2014.

(51) Int. Cl. G06F 9/44; G06K 9/46

(52) U.S. Cl. CPC G06F 8/34; G06K 9/46

(57) ABSTRACT

Systems and methods for automatic imaging and generation of executable processor instructions based on ordered objects, such as blocks are disclosed. According to an aspect, a method may be implemented by a computing device including one or more processors and memory. The method may include capturing an image of multiple, ordered objects. The method may also include translating the captured image into processor instructions. Further, the method may include executing the processor instructions.

### CROSS REFERENCE TO RELATED APPLICATION

This application claims priority to U.S. provisional patent application No. 62/053,206, titled SYSTEMS AND METHODS FOR IMAGING AND GENERATION OF EXECUTABLE PROCESSOR INSTRUCTIONS BASED ON ORDERED BLOCKS, and filed Sep. 21, 2014, the disclosure of which is incorporated herein by reference in its entirety.

### TECHNICAL FIELD

The present disclosure relates to automatic executable code generation, and more specifically, to systems and methods for automatic imaging and generation of executable processor instructions based on ordered blocks.

### BACKGROUND

As can be appreciated, normal sighted persons can easily interact with computers, including applications executed on the computer. Such computer applications can include word processors, spreadsheets, or even applications intended to write processor instructions or code, such as other applications, to be executed on the computers. Such computer applications are nearly always based on fairly complex graphical user interfaces (GUIs), not to mention the inherent complexity of computer code in general. Normal sighted persons usually find GUIs intuitive and easy to interact with. However, except for an occasional “beep” sound for example, GUIs are virtually silent, and the vast majority of the information they provide to the user is visual. Thus, GUIs are essentially unusable by blind or severely visually-impaired people.

There are adaptive technologies that aid the blind and visually impaired computer users. Some of these adaptive technologies include speech synthesis, large-print processing, and voice recognition. However, presently, almost none of the foregoing tools are adapted for use with GUIs. It has been suggested that programmers could write software with built-in voice labels for icons. Various synthetic or recorded speech solutions for making computer display screen contents available to blind persons have also been proposed. Additionally, there have been suggested systems that include a mouse with a braille transducer so that a blind user may read text and obtain certain tactile position feedback from the mouse. However, while announcing various text items, either audibly or by means of a braille transducer in the mouse, may provide some information to blind user, it does not enable the user to navigate about and locate objects on the computer display screen, or draft programming code.

Other adaptive technologies have included an audible cursor positioning and pixel (picture element) status identification mechanism to help a user of an interactive computer graphics system locate data by using aural feedback to enhance visual feedback. As the cursor is stepped across the screen, an audible click is generated that varies in tone corresponding in tone to the current status of each pixel encountered. With this combination in audible and visual cursor feedback, it is intended to identify the desired line by noting the change in tone as the cursor moves. However, each of the described technologies above allow for a significant amount of imprecision in the computer interaction process making it difficult, if not impossible, for a blind or visually impaired person to write processor instructions for a computer.

In view of the foregoing, there is a need for assisting blind and visually impaired people to write programming code or otherwise interact with a computer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for automatic imaging and generation of executable processor instructions based on ordered objects, such as blocks. According to an aspect, a method may be implemented by a computing device including one or more processors and memory. The method may include capturing an image of multiple, ordered objects. The method may also include translating the captured image into processor instructions. Further, the method may include executing the processor instructions.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1A is a block diagram of an example computing device for automatic imaging and generation of executable processor instructions based on ordered objects in accordance with embodiments of the present disclosure;

FIG. 1B is an image of play construction blocks ordered for image capture for generation of processor instructions in accordance with embodiments of the present disclosure;

FIG. 2 is a flowchart of an example method for automatic imaging and generation of executable processor instructions based on ordered blocks in accordance with embodiments of the present disclosure;

FIG. 3 is a block diagram of an example system of automatic imaging and generation of executable processor instructions for controlling robotic components based on the ordered blocks according to embodiments of the present disclosure;

FIG. 4 is a block diagram of an example system of automatic imaging and generation of executable processor instructions for controlling a mobile robot based on ordered blocks according to embodiments of the present disclosure;

FIGS. 5 and 6 are images of example arrangements of ordered blocks according to embodiments of the present disclosure;

FIG. 7 is a screen display showing a software interface of RFID technology to implement “COBRIX” in accordance with embodiments of the present disclosure;

FIG. 8 is an image showing a top view of an arrangement of ordered blocks with white labels attached to represents the integration of RFID chip or sensor to a LEGO® block; and

FIG. 9 illustrates screen shots of a programming tutorial for COBRIX. A similar type of play may be implemented with the present subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. In another example, a computing device may be a server or other computer and communicatively connected to other computing devices (e.g., handheld devices or computers) for data analysis. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

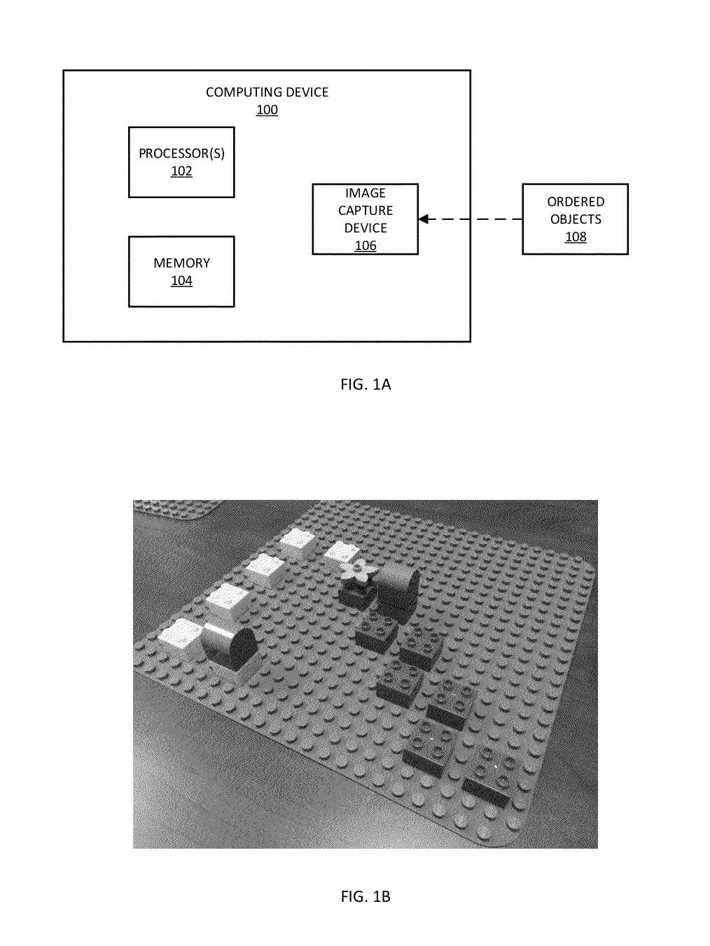

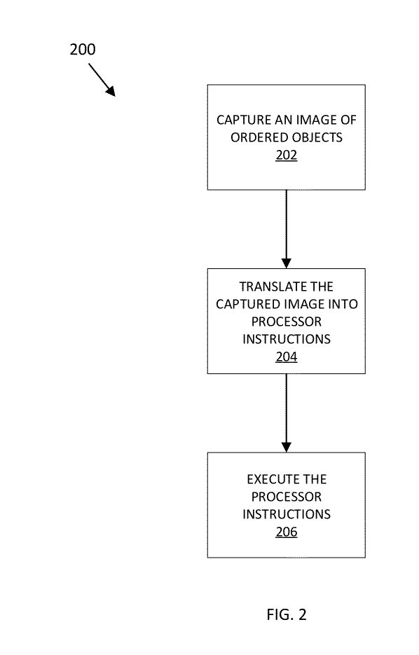

FIG. 1A illustrates a block diagram of an example computing device 100 for automatic imaging and generation of executable processor instructions based on ordered objects 102 in accordance with embodiments of the present disclosure. Referring to FIG. 1A, the computing device 100 can include one or more processors 102 and memory 104 configured to operate for implementing functionality described herein in accordance with embodiments of the present disclosure. Alternatively, the functionality may be implemented by any suitable hardware, software, firmware, or combinations thereof. The computing device 106 may be a smartphone or tablet computer, for example.

The computing device 106 include an image capture device 106 operably connected with the processor(s) 102 and memory 104 for capturing images. For example, the image capture device 106 can be a camera, such as a digital camera. The image capture device 106 may be operated by a user of the computing device 106 for capturing still images or video as will be understood.

The computing device 106 may be oriented such that the image capture device 106 faces ordered objects 108. The ordered objects 108 may be play construction blocks that have been arranged by a user to represent programming or processor instructions. For example, the ordered objects 108 may represent the programming or processor instructions based on their color, shape, size and positioning with respect to one another. Example blocks include, but are not limited to, LEGO DUPLO®, or K'NEX® play construction blocks. After capture of one or more images or video of the objects 108, the corresponding data may be stored in memory 104. Subsequently, the processor(s) 102 may process the image data and recognize the objects 108 in the captured image data. The processor(s) 102 may interpret and identify the color, shape, size, and positioning of the ordered objects 108 in the captured digital image. Once the ordered objects 108 are identified and located, the processor(s) 102 may be configured to translate the captured images of the ordered objects 102 into executable processing instructions that may be executed by the computing device 100. The instructions may be stored in memory 104, for example.

In accordance with the aforementioned example, the computing device 100 may be used by a visually-impaired user for generating processor instructions. More particularly, the user may order the objects 108 in a particular way to program the computing device 110 or other devices configured to receive processor instructions. Additionally, users may program the computing device 102 with the ordered blocks 102, arranging the ordered blocks 102 spatially so as to represent instructions, syntax, or secondary notation. As an example, secondary notation may be position, indentation, and symmetry of the generated programming code or processor instructions. While the secondary notation may not affect the programming behavior of the program, the resulting translated processor instructions may be formatted for easier reading by others. The translation of the ordered objects 108 may also be manipulated according to the type and extent of the physical elements used as described above. The ordered objects 108 may be interactively manipulated according to some specific spatial grammar for processor instructions.

With continued reference to FIG. 1A, some example processor instructions may be used for computing device 102 input. As an example, input type instructions may be for gathering data from physical elements, sensors, or spatial arrangements of physical elements. Another example of a processor instruction may be display type instructions to enable the display of data on the screen, or send data to a file or other device. A further example of a processor instruction may be an arithmetic instruction, wherein basic or complex arithmetical operations are performed such as addition or subtraction. Another example of a processor instruction may be to provide for conditional execution, such as checking for certain conditions and executing the appropriate sequence of statements based on the condition. Additionally, another example of a processor instruction may be to provide for repetition, performing some action repeatedly with or without variations, such as a loop or for/next instruction. As an example, a 4×2 sized, green, ordered, play construction blocks may represent a processor instruction to instruct the robot to “move forward” or a 4×2 sized, red, ordered, play construction blocks may represent a processor instruction to instruct the robot to “turn right” or “turn left”. Other processor instructions may be a 1×1 sized, red, ordered, play construction block may indicate the beginning of a conditional branch, such as a “do/else” or an 8×2 sized, green ordered block 102 may indicate an “if” statement and an 8×2 sized, blue, ordered, play construction block may represent a “repeat/until” statement. The ordered blocks may also be combined to generate compound instructions, such as, an 8×2 ordered block with a “turn left” ordered block which may instruction the robot to detect and move forward on a path to the left of the robot's present location, as an example. The examples described are non-limiting and it is noted that any processor instruction may be represented by a particular color, shape, sized block or any combination of color, shape or size. FIG. 1B is an image of play construction blocks ordered for image capture for generation of processor instructions in accordance with embodiments of the present disclosure.

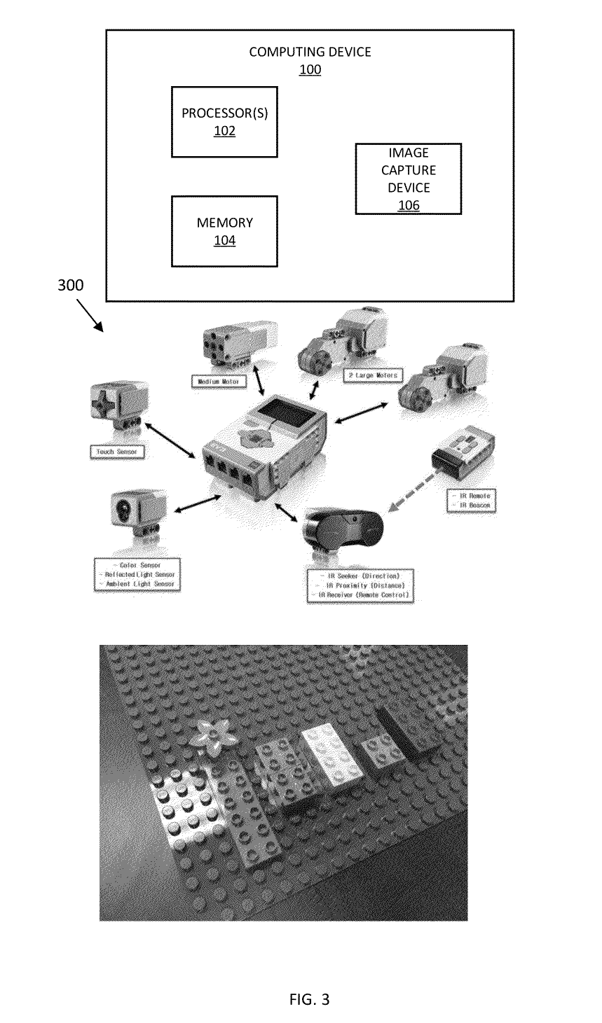

FIG. 2 illustrates a flowchart of an example method 200 for automatic imaging and generation of executable processor instructions based on ordered blocks 102 in accordance with embodiments of the present disclosure. It is noted that reference is made to FIG. 1 as implementing the example method described in FIG. 2, although it should be understood that any suitably configured computing device can implement the method of FIG. 2.

Referring to FIG. 2, the method 200 includes capturing 202 an image of the plurality of ordered objects. For example, a user of the computing device 100 may direct the computing device 100 such that the image capture device 106 can capture one or more images of the ordered objects 108. The user may then interact with the computing device 100 for capturing the image(s) such as by interacting with a touchscreen as will be understood. The ordered objects 108, as described above, may be of various colors, shapes, sizes, and positioning.

The method of FIG. 2 includes translating 204 the captured image into processor instructions. Continuing the aforementioned example, the processor(s) 102 may identify the ordered objects 108 as representing different processor instructions. As an example, a processor instruction may be an instruction for a for/next loop, if/then conditional branch, a mathematical calculation or an output command to be sent to a device, such as a robot or motor or other sensing device.

With continuing reference to FIG. 2, the method includes executing 206 the processor instructions translated based on the ordered objects 108. Continuing the aforementioned example, the processor instructions may be stored in memory 104 and executed by the processor(s) 102.

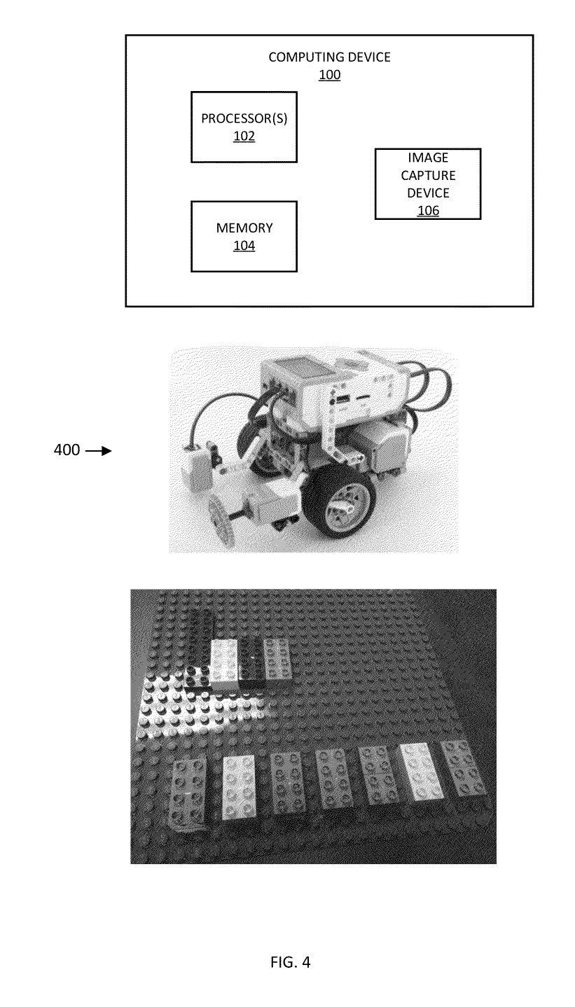

FIG. 3 illustrates a block diagram of an example system 100 of automatic imaging and generation of executable processor instructions for controlling robotic components 300 based on the ordered blocks according to embodiments of the present disclosure. The robotic components 300 may include a micro-controller. As an example, the micro-controller may be an ARDUINO®, a RASPBERRY PI®, or LEGO MINDSTORMS® micro-controller. The micro-controller may be used to execute the received processor instructions from the computing device 102. The robotic components 300 may include sensor, motor or indicator components. The sensor, motor or indicator components may receive input, output, or other processor instructions as appropriate for the component. As an example, sensor components may gather data such as temperature, illumination, proximity, or other sensor for determining environmental or surrounding data by the micro-controller. The motor component may be a servo or drive motor, as an example. The indicator component may be a light, buzzer, display or other indicator type component. An example of arrangement of blocks for controlling the robotic components 300 is depicted in the image at the bottom of FIG. 3.

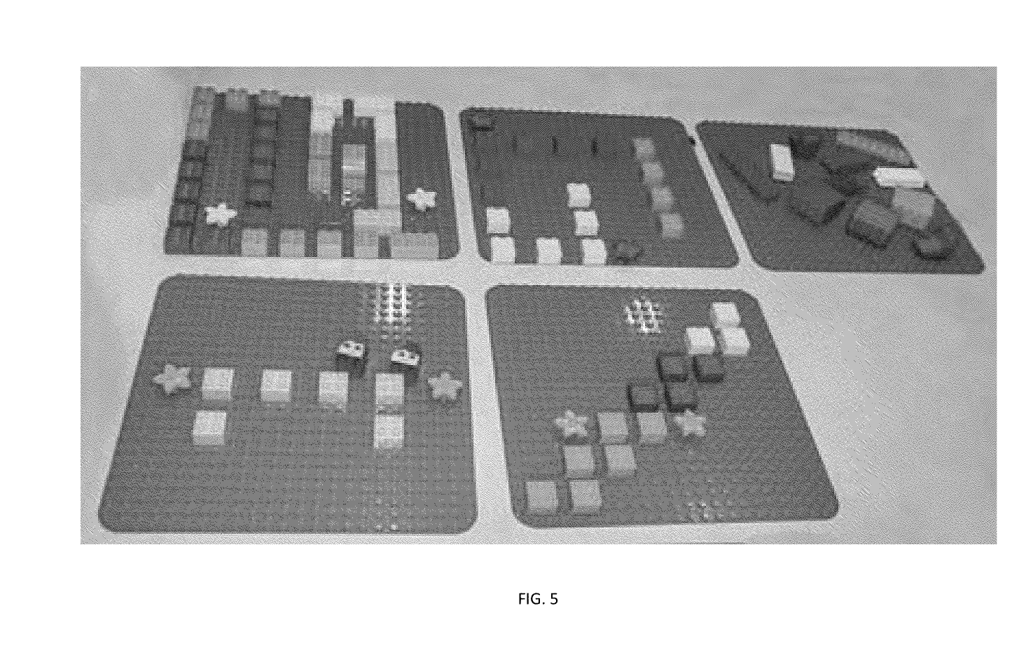

FIG. 4 illustrates a block diagram of an example system of automatic imaging and generation of executable processor instructions for controlling a mobile robot based on ordered blocks according to embodiments of the present disclosure. Referring to FIG. 4, an example of a robot 400 using the robotic components 300 shown in FIG. 3 is provided. It is noted that reference is made to FIG. 3 robotic components 300 as implementing the example robot 400 described in FIG. 4, although it should be understood that any suitably configured robot can implement the robot 400 of FIG. 4 with any programmable robotic component 300.

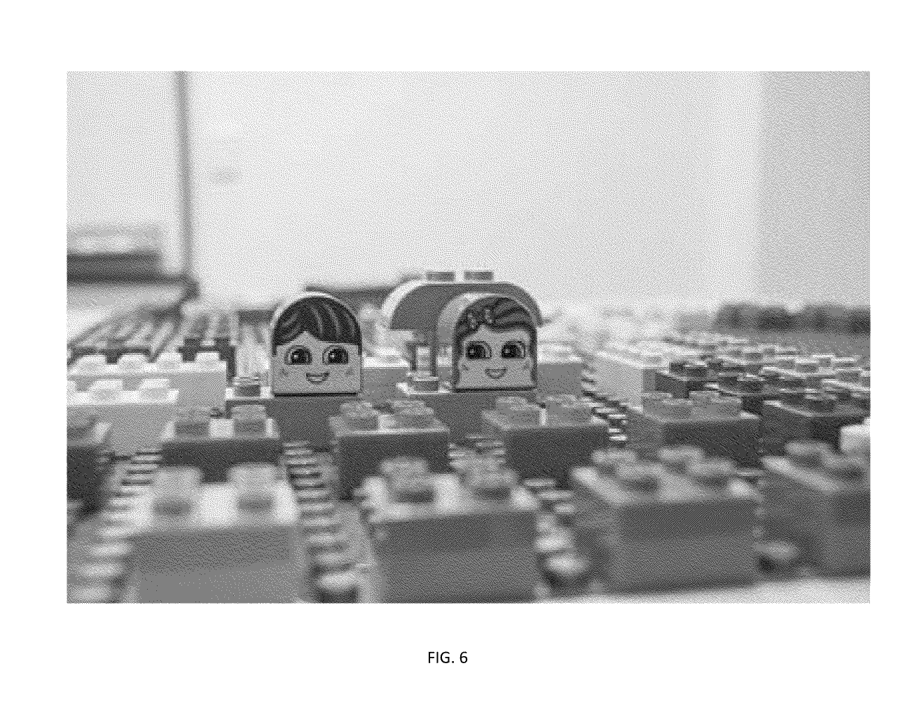

FIGS. 5 and 6 illustrate images of example arrangements of ordered blocks according to embodiments of the present disclosure. It is noted that the ordered blocks, as described above, may be used to implement any programmable processor instruction based on the color, shape, size, or positioning of the ordered blocks. The processor instructions generated may be used for creating applications for any computing application and not limited to the specific examples described above. The computing device 102 may be configured to store the translated set of processor instructions on a storage medium (e.g, hard drive, cloud storage, USB thumb drive, etc.). The computing device 102 may also be configured to capture the image of the ordered blocks based on detecting the position of the ordered blocks using radio-frequency identification (RFID) technology. Alternatively, the capture the image of the plurality of the ordered blocks may be based on detecting the position of the ordered blocks using electromagnetic detection of the ordered blocks. In each of the described non-limiting examples, RFID and electromagnetic detection of the positioning of the ordered blocks, the color, shape, size and positioning of each ordered block may be determined. FIG.

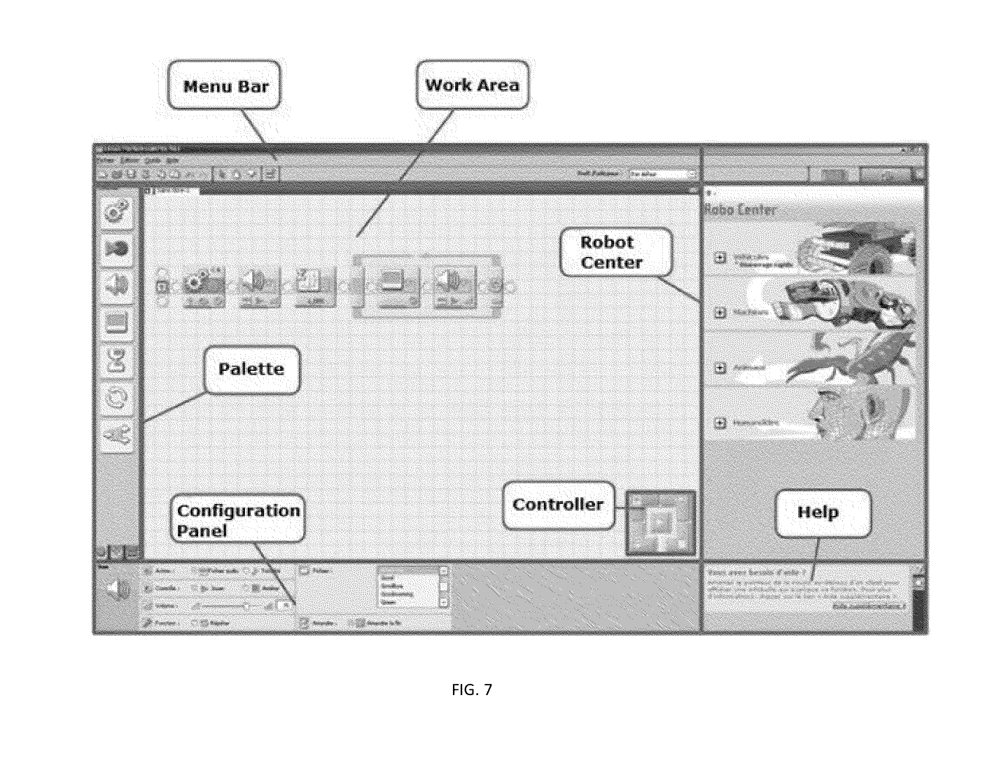

FIG. 7 is a screen display showing a software interface of RFID technology to implement “COBRIX” in accordance with embodiments of the present disclosure. Referring to FIG. 7, the interface depicts the integration of RFID technology to implement “COBRIX”. This idea is incorporated herein.

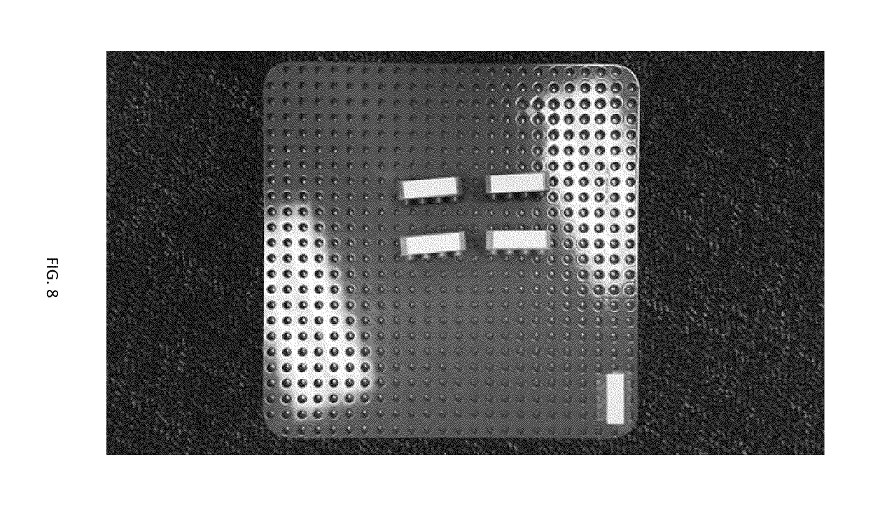

FIG. 8 is an image showing a top view of an arrangement of ordered blocks with white labels attached to represents the integration of RFID chip or sensor to a LEGO® block. Instead of capture of an image of the order and arrangement of LEGO® block in accordance with examples described herein, RFID sensors can be used to deliver the location information of bricks to the software. Also, the LEGO® block would be working as input reader from bricks.

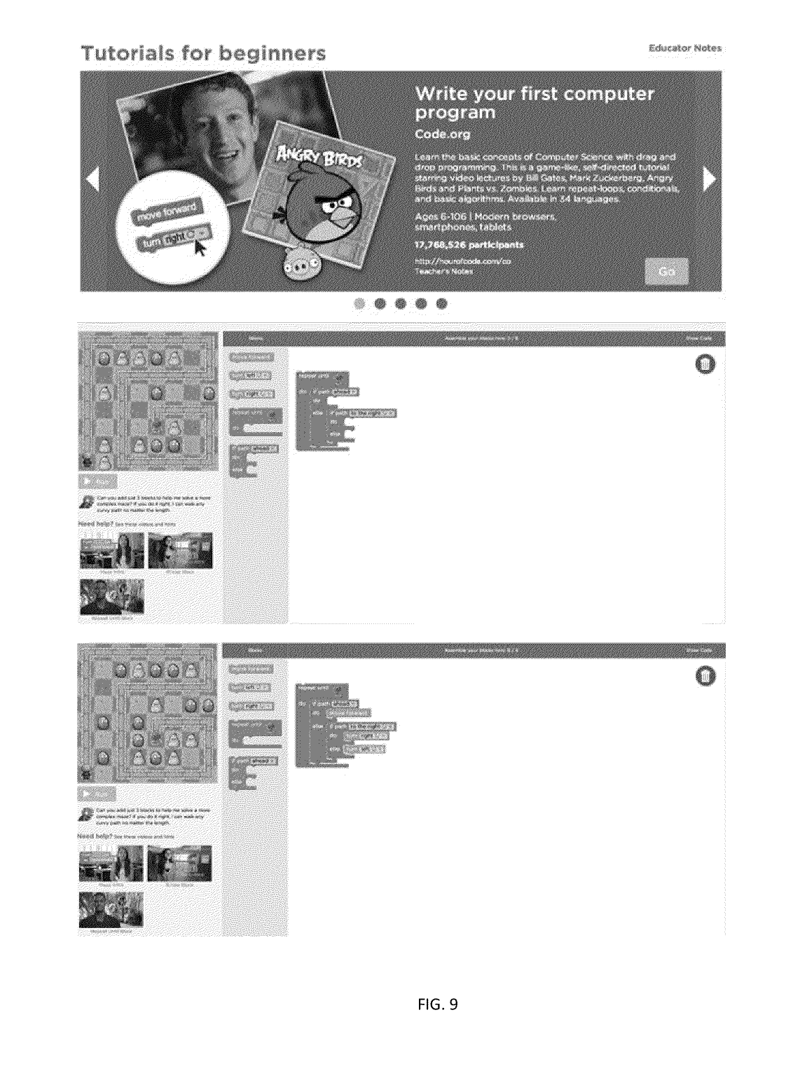

FIG. 9 illustrates screen shots of a programming tutorial for COBRIX. A similar type of play may be implemented with the present subject matter.

In accordance with embodiments, objects could be associated with augmented reality (AR) tags that are recognizable by a computing device for generating executable processor instructions. AR is a live direct or indirect view of a physical, real-world environment whose elements are augmented by a computer. In an example, a computing device may be configured to recognize objects and their positioning based on AR to generate executable processor instructions.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a computing device comprising at least one processor and memory:
capturing an image of a plurality of ordered objects;
translating the captured image into processor instructions; and
executing the processor instructions.

2. The method of claim 1, further comprising:
storing the translated processor instructions in the memory; and
retrieving the stored processor instructions prior to execution.

3. The method of claim 1, wherein executing the processor instructions comprises using the at least one processor to execute the processor instructions.

4. The method of claim 1, wherein executing the processor instructions comprises using a processor of another computing device to execute the processor instructions.

5. The method of claim 1, further comprising determining a color of each of the objects, and
wherein translating the captured image comprises translating the captured image into the processor instructions based on the determined colors of the object.

6. The method of claim 1, wherein the objects comprise blocks.

7. The method of claim 1, further comprising displaying the processor instructions on a display.

8. A method comprising:
detecting one of positions and orientations of a plurality of objects;
translating information about the detected one of positioned and orientations of the objects into processor instructions; and
executing the processor instructions.

9. The method of claim 8, wherein detecting one of positions and orientations of a plurality of objects comprises electromagnetically detecting the one of positions and orientations of the objects.

10. The method of claim 8, further comprising detecting a shape of each of the objects, and
wherein translating information comprises translating information about the detected one of positioned and orientations of the objects into processor instructions based on the detected shapes of the objects.

11. The method of claim 8, wherein detecting one of positions and orientations of a plurality of objects comprises detecting the one of positions and orientations of the objects using radio-frequency identification (RFID) technology.

12. The method of claim 8, wherein the objects comprise blocks.

13. A computing device comprising:
using an image capture device to capture an image of a plurality of ordered objects; and
at least one processor and memory configured to:
translate the captured image into processor instructions; and
execute the processor instructions.

14. The computing device of claim 13, wherein the at least one processor and memory are further configured to:
store the translated processor instructions in the memory; and
retrieve the stored processor instructions prior to execution.

15. The computing device of claim 13, wherein the at least one processor and memory are further configured to:
determine a color of each of the objects; and
translate the captured image into the processor instructions based on the determined colors of the object.

16. The computing device of claim 13, wherein the objects comprise blocks.

17. The computing device of claim 13, further comprising a display configured to display the processor instructions.
